(19) United States
(12) Patent Application Publication
(10) Pub. No.: US 2008/0262956 A1
(43) Pub. Date: Oct. 23, 2008

(54) System and Method for High-Yield Investment Returns in Riskless-Principal Interest Rate/Yield Arbitrage

(76) Inventor: Alain L. De La Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/578,888

(22) PCT Filed: Apr. 20, 2005
(86) PCT No.: PCT/US05/13489

§ 371 Date: Apr. 17, 2008

Related U.S. Application Data
(60) Provisional application No. 60/564,044, filed on Apr. 20, 2004.
(60) Provisional application No. 60/564,068, filed on Apr. 20, 2004.
(60) Provisional application No. 60/563,904, filed on Apr. 20, 2004.
(60) Provisional application No. 60/569,836, filed on May 10, 2004.
(60) Provisional application No. 60/569,878, filed on May 10, 2004.
(60) Provisional application No. 60/615,130, filed on Oct. 1, 2004.
(60) Provisional application No. 60/630,234, filed on Nov. 22, 2004.
(60) Provisional application No. 60/630,233, filed on Nov. 22, 2004.
(60) Provisional application No. 60/634,897, filed on Dec. 8, 2004.
(60) Provisional application No. 60/654,208, filed on Feb. 17, 2005.

(51) Int. Cl. G06Q 40/00

(52) U.S. Cl. 705/37

(57) ABSTRACT

A multi-participant financial transaction with no downside risks that results in a net profit for all participants (FIG. 2) when the transaction is accomplished according to certain required steps, including the step of having simultaneously closings in escrow. A multi-step approach to issuing and selling custom-designed, specially engineered and underwritten securities or bank instruments is also described.

### CROSS-REFERENCE TO RELATED APPLICATIONS

This application claims priority to the following U.S. Provisional Patent Applications: (i) Ser. No. 60/564,044, filed Apr. 20, 2004 and entitled “System and Method to Increase the Refinancing Leverage in a Profitable Transaction Involving an Arbitrage of Yield Differentials Between Two Financial Products”; (ii) Ser. No. 60/564,068, filed Apr. 20, 2004 and entitled “System and Method for High-Yield Returns in Arbitrage of Yield Differentials Achieved Through: (a) Structured Insurance Products, and (b) the Exercise of Call and Put Options; (iii) Ser. No. 60/563,904, filed Apr. 20, 2004 and entitled “System and Method for an Insurance Company or a Bank to Increase its Sales and Subsequently its Profits Through the Repurchase (repo) of its Own Special Guaranteed Insurance Contract (or Bank Investment Contract) Purchased from an Unrelated 3^{rd} Party”; (iv) Ser. No. 60/569,878, filed May 10, 2004 and entitled “System & Method for High-Yield Returns in “Riskless-Principal” Interest Rate/Yield Arbitrage that Calls for: (a) the Creation of Structured Derivative, Specialty Insurance or Synthetic Asset Products Specifically Engineered to Increase the Financial Leverage in a Transaction; (b) the Use of Option Agreements (Put & Call) to Arbitrage Market Differentials in Interest Rates & Yields, and (c) a “Repol” Mechanism to Create Immediate Profits for the Original Issuer”; and (v) Ser. No. 60/615,130, filed Oct. 1, 2004 and entitled “System & Method for Banks to Maintain Maximum Benefit Offered Member Banks by the Central Banks Through: (a) The Lending Leverage Available Under Fractional Reserve Banking Practices [e.g. 10:1 Leverage in the USA, 20:1 in Canada], and (b) Interest Rate Arbitrage [e.g. Retail Interest Rates less the Central Bank Discount Rate], Through a Mirror Offset of Counterparty Risk and Without Resorting to Traditional Repo Mechanisms; all of which are incorporated herein by reference.

### TECHNICAL FIELD

The invention relates to investment methods and arbitrage, and more specifically to System & Method for High-Yield Investment Returns in Riskless-Principal Interest Rate/Yield Arbitrage that Calls for: (a) the Creation of Structured Derivative, Specialty Insurance or Synthetic Asset Products Specifically Engineered to Increase the Financial Leverage in a Transaction; (b) the Use of Options (Put & Call) to Arbitrage Market Differentials in Interest Rates & Yields, and (c) a “Repo” Mechanism to Create Immediate Profits for the Original Issuer and the transaction participants.

### BACKGROUND

Financial investment methods have been known and performed for many years. Each of those methods includes an investment activity that involves a certain amount of risk for an investor. The investor invests money, and, according to conventional financial investment methods, the investor takes the risk of either making or losing money, and possibly losing all money invested.

Conventional investment methods also include a practice known as arbitrage, however conventional arbitrage methods carry similar risks for investors.

Until now, there have been no investment methods known in which investors can make a riskless-principal investment (without a downside risk), and in which parties of a multi-party financial transaction can be assured of a profit.

### SUMMARY OF THE INVENTION

In one version, the invention may be thought of as performing a multi-participant financial transaction that will result in a net profit for all participants when the transaction is accomplished according to the below-described steps, and including the step of having simultaneously closings in escrow. The invention involves the issuance and sale of custom-designed, specially engineered and underwritten securities or bank instruments as described generally below, and more specifically in the detailed description that follows.

In another version, the invention may be thought of as a method of performing a multi-participant financial transaction that includes a lender and that will result in a net profit for all participants. That method includes acquiring and reselling an investment portfolio formed from plural financial instruments via a simultaneous escrow closing, thereby making a riskless-principal transaction wherein the refinancing proceeds are exchanged against delivery of all rights, title and interest to the investment portfolio to the lender.

In another version, the invention may be thought of as a method of performing an investment cycle with multiple participants that will result in a net profit for all participants. That method includes the steps of underwriting an investment portfolio formed from plural financial instruments; purchasing the investment portfolio as part of a simultaneous escrow closing that requires plural closing documents and exchanging simultaneously all closing documents; and aborting the simultaneous escrow closing in the event the simultaneous escrow closing does not occur within a preselected time, thus eliminating any and all transaction risks for all participants. That method also includes the steps of exercising a call option, in escrow, and choosing a simultaneous-investment-portfolio-refinancing mechanism that functions in escrow and includes an exit strategy substep chosen from one of several substeps. The substeps include performing a defeased refinancing of the investment portfolio; forfeiting the financial instruments in the investment portfolio at a price based upon the relationship of the income stream of the instruments to their present value at a yield-to-maturity desirable to a third-party buyer; selling the investment portfolio to one of the issuers of the financial instruments; or combinations of at least two of the substeps. That method may also include the step of repeating the investment cycle.

### BRIEF DESCRIPTION OF THE DRAWINGS

FIG. 1 is a chart showing an example of a specially-designed instrument No 1 used in connection with the system and method of the invention.

FIG. 2 is a chart illustrating in graphic form the basic design concepts incorporated in the engineering of instrument No 1, including the annual and cumulative payment obligations, the cash surrender values for each contract anniversary years, and the issuer deferred income (or reserves) shown in FIG. 1. The chart shows how a financial product having a $500 Million face value will be created and paid for with only a first annual payment obligation of $19,240,533 (a 26:1 leverage).

FIG. 3 is a chart that shows the engineering of instrument No 2 (a higher-yielding annuity-certain form of instrument) designed to create a future cash flow sufficient to pay for the last nine payment obligations created by instrument No 1 when it is acquired. The combination of instrument No 1 shown in FIG. 1 and an instrument No 2 used in connection with the system and method of the invention creates a financial product that can be used to secure an indebtedness.

FIG. 4 is a chart showing an example of an instrument No 3 used in connection with the system and method of the invention. This instrument is designed to create the cash flow necessary to meet the future interest payments on a loan.

FIG. 5 is a chart that illustrates how the call option strike price for the acquisition of the investor portfolio is calculated for the example described herein.

FIG. 6 is a schematic diagram showing certain escrow closing steps that are required by the invention to result in a profit for the transaction manager and to eliminate any and all risks for the investor and the transaction manager through a forfaiting process involving a non-recourse refinancing.

FIG. 7 is a chart that shows escrow distributions and how to calculate the transaction profit to the transaction manager when using or practicing the system and method of the invention.

FIG. 8 is a chart that demonstrates the significance of a bridge loan and how the bridge lender profits from making the bridge loan when using and practicing the system and method of the invention.

FIG. 9 is a chart describing details of a repo step/feature of the method and system of the invention, which step/feature is to be performed by the issuer of instrument No 1.

FIGS. 10-11 are charts showing alternate methods of issuing financial products when using and practicing the system and method of the invention.

FIG. 12 is a chart showing the details of a final exit with resale of financial instruments No 2 and 3 used and practiced with the system and method of the invention to their original issuer/s.

FIG. 13 is a schematic diagram showing how the resale of the derivatives of instruments No 2 and No 3 are packaged in stages to enable issuers of those debt instruments to retain them on their respective balance sheets.

Also included with this application are Attachments A-F. The figures in Attachment A are described and referenced below, and Attachments B-F correspond to U.S. provisional patent application from which priority is claimed.

### DESCRIPTION OF THE PREFERRED EMBODIMENT

Preliminarily, the percentages, amounts, numbers, rates, etc, recited in this specification are for illustrative purposes only and do not reflect what is optimally or minimally achievable under the invention. Each transaction involves its own set of particulars and numbers that can be calculated with accuracy prior to a particular closing.

Also preliminarily, a glossary of the terms used in the present application follows.

The phrase “annuity certain annuity” is a form of contract sold by an insurance company that pays a guaranteed monthly, quarterly, semi-annual or annual level of income to the annuitant for a predetermined period of time, frequently ten years, without exception or contingency.

The term “arbitrage” describes the process by which a profit is achieved through a positive advantage derived from an investment yield greater than the refinancing cost, and the application of time value of money calculations to reduce future cash flow streams to their present values. As used herein an arbitrage advantage also exists in cross currency investments and refinancing (e.g. an investment is made in Mexican Peso with a yield to maturity of 10% per annum while a refinancing is simultaneously executed in Japanese Yen at 1.5% per annum, and a shorter term currency hedge is placed to eliminate currency fluctuation risks just to cover the period between the closing and the repo/swap process envisioned herein). The term arbitrage is also used herein to describe the yield advantage that financial institutions derive between the retail lending rates and the (wholesale) inter-bank discount rates for refinancing (refer to “fractional reserve banking” below).

A “bank guarantee” or “standby letter of credit” is usually an irrevocable and unconditional undertaking of the issuing bank to pay directly the holder thereof the face value of the guarantee under certain conditions (e.g. non payment of a debt by the debtor) with such payment being made in the place of the debtor. Such an instrument shifts the responsibility for payment of an obligation to the bank that issues the guarantee. The counterparty risk (see definition below) is normally based on the financial strength of the bank or financial institution issuing the guarantee.

A “bank investment contract” or “BIC” is a bank-guaranteed interest in a portfolio providing a specific yield over a specified period. The insurance company equivalent is a Guaranteed Investment Contract as defined below.

A “bond” is an interest-bearing or discounted government or corporate security that obligates the issuer to pay the bondholder a specified sum of money, usually at specific intervals, and to repay the principal amount of the loan at maturity. Bonds are normally backed by collateral but can also be based on the credit strength of the issuer.

A “bridge lender” is a party, usually a bank or financial institution, that makes a bridge loan (or swing loan) in anticipation of a short, intermediate or long-term refinancing which is sure to occur in the future.

A “bridge loan” is a loan made available to a borrower by a Bridge Lender in anticipation of a more definitive refinancing which is sure to occur. The “bridge” can be for anywhere from a few hours to several months.

A “cash surrender value” or “CSV” in insurance is the amount the insurer will return to a holder of an instrument in the event the instrument is surrendered to the insurance company or on cancellation of the insurance instrument. In this invention, the cash surrender value also applies to the agreed upon redemption price of instruments if redeemed or repurchased earlier than the maturity date and whether such instrument is issued by an insurance company or not.

A “Central Bank” is a country's bank that (1) issues currency; (2) administers monetary instrument, including open market operations; (3) holds deposits representing reserves of other banks; and (4) engages in transactions designed to facilitate the conduct of business and protect public interest.

A “certificate of deposit” is a debt instrument issued by a bank that usually pays interest.

A “collateral” is an asset pledged to a lender until a loan is repaid. If the borrower defaults, the lender has the legal right to seize the collateral and sell it to pay off the loan.

A “coupon” is a detachable certificate showing the amount of interest payable to a bond or note holder at regular intervals, ordinarily semi-annually. Bond interest on book-entry securities is credited to the owner's account.

The “coupon rate” is the nominal annual rate of interest the issuer of a note or bond promises to pay the holder during the period the securities are outstanding.

The phrase “coupon stripping” is a process of separating the interest on a bond or note from the underlying principal. Coupon stripping is used most often to create US Treasury zero coupon securities known as “strips”.

A “counter-party” is the person at the opposite side of a repurchase (repo) agreement or swap agreement. The person who agrees to sell back securities sold in a repurchase agreement, or exchange at a later date currency values or interest rates in a swap agreement with another party.

A “counter-party risk” is the credit risk associated with a particular counter-party.

A “credit-derivative” (also known as a “collateral trust note” or “collateral trust bond”) is a debt security backed by other securities, usually held by a bank or other trustee. Such notes or bonds are usually backed by collateral trust certificates and are usually issued by parent corporations that are borrowing against the securities of wholly-owned subsidiaries.

A “credit-linked note” is a credit derivative which allows the issuer to set-off the claims under an embedded credit derivative contract from the interest, principal, or both, payable to the investor in such note. The credit risk of a credit-linked note is the same as that of the issuer risk associated with the underlying asset pool.

The term “currency” means any lawful money of a country issued by the Central Bank. In this example we have used the United States Dollar as the currency of choice, but the invention is applicable to any currency.

A “debt instrument” is a written promise to repay a debt, evidenced by an acceptance, promissory note, or bill of exchange. The term also applies to formal debt securities such as bonds and debentures.

The terms “defeasance” or “defeasement” apply to a refinancing technique in which a note or bond issuer, instead of redeeming the instruments at the call date, continues to make coupon interest payments from an Irrevocable Trust and has deposited into the trust assets that will be used for the repayment of principal at maturity. The cash flow from trust assets, ordinarily U.S. Treasury securities or zero-coupon securities, must be sufficient to service the instruments until the expected maturity. Defeasance effectively removes the instruments from the issuer's balance sheets, even though the issuer continues to meet bond interest payments. For the purpose of this invention defeasement is used in the sense that any and all risks associated with the debt service (principal and interest) has be shifted to the issuer of the instruments that are part of the portfolio of collateral with the resulting benefit that the credit risk for the lender is not based on the balance sheet strength of the transaction manager, but on that of the issuer of the collateral.

A “defeased loan” means a loan in which the credit risk associated with a particular loan has been shifted from that of the borrower's financial strength to a 100% reliance on the credit risk associated with the issuer of the securities or debt instruments offered as collateral in a secured loan transaction. In this invention a defeased loan refers to the process of offsetting the debt service obligations of the borrower (through a security/pledge & assignment) with the income to be earned from one or more securities of a third-party issuer that provides 100% of the cash flows necessary to meet any and all debt service obligations of the borrower to the lender.

A “derivative instrument” is a contract whose value is based on the performance of an underlying financial asset, index or other investment. For example an ordinary option is a derivative because its value changes in relation to the performance of an underlying stock.

The phrases “discounting” or “rediscounting” is the process by which a credit is obtained by a financial institution through the pledge of its collateral (e.g. notes, acceptances, etc.). A bank can refinance its collateral portfolio through the process known as discounting as is the case in the “Borrower in Custody” program of the Federal Reserve Bank of the United States or through the inter-bank loan market (e.g. “LIBOR” or “London Inter-Bank Overnight Rate”). Discounting is also the process of estimating the present value of an income stream by reducing the expected cash flow to reflect the time value of money. Discounting is the opposite of compounding.

A “discount rate” is the interest rate the Central Bank (e.g. the Federal Reserve Board) charges member banks for loans, using government securities or eligible financial instruments as collateral.

A “discount”, when used in respect of bond or note, normally refers to the price of the instrument expressed as a percentage of the face value (see below). When it is said that a bond is sold at a discount it refers to a price below 100% of face. Similarly, a premium is any price paid that is above 100% of face. Bond prices rise when interest rates fall and prices decline when interest rates go up.

The phrases “escrow assets” or “simultaneous escrow closing assets” represent the money, securities, or other property or instruments held by a third party (e.g. a law firm or title company acting as the escrow agent) until all the conditions of a contract are met whereupon the “escrow” closes and the assets held in safekeeping are distributed to each party in accordance with the terms and conditions of the contract. In the case of a simultaneous escrow closing, all conditions must be met before the escrow can close. The following terms and conditions usually apply in such cases: “The delivery of the instrument and payment of the purchase price and the closing shall be simultaneous in that neither the delivery of the instruments, payment of the purchase price nor any event required by the terms of this Agreement to occur thereat shall be deemed to have occurred until such delivery, payment and all such events shall have occurred, and when such delivery, payment and all such events have occurred, they shall be deemed to have occurred simultaneously. In the event the closing does not occur within X business days of the scheduled closing date, all funds, instruments and other assets held in escrow will be immediately returned to the original depositor.”

The “face value” of a bond, note, or other security is the value given on the face of certificate or instrument.

“Forfaiting” is a method of financing (with fixed or floating interest rate) that eliminates all risks by selling a receivable on a “non-recourse” basis in exchange for immediately available cash.

The phrase “fractional reserve banking” is the method by which banks that are members of a Central Bank are required to maintain a fraction of bank depositors' funds in a non interest-bearing account as a “reserve” to pay-off depositors in the event they demand their funds back. This simply means that a bank can lend out $10,000 for every $1,000 maintained on deposit (10:1 leverage). Banks are further required to maintain a healthy Tier I (100% at-risk capital of the bank) and Tier II (bank capital that is not 100% at-risk, e.g. capital that includes an element of priority, preference or return guarantee) capitalization levels. Central Banks use Fractional Reserve Banking as a money multiplier in the economy e.g. Bank A receives deposits of $100 and lends out $90 which the borrower X then deposits at Bank B. Bank B receives $90 and lends out $81 to borrower Y, etc. until there is a zeroing out occurs in the economy. The practical application of this principle is that banks profit significantly by applying two principles of banking: (a) the leverage (currently 10:1 in the USA; 20:1 in Canada; 12.5:1 in Europe, etc.) of depositor funds that can be loaned or invested (e.g. loans to the government through the purchase of Treasury instruments) as explained below, and (b) the Discounting or Rediscounting at an interest rate that is lower (wholesale rate) than the rate at which funds are lent or placed into the market (retail rate). The compounding of Leverage and Discounting results is massive profits for the banking industry, assuming, of course, that loan defaults are maintained at a reasonable level. Referring to Attachment A, Fig. A1 describes the process banks use to create a profit from depositor funds through a process of retail loans following by a discounting mechanism through the central bank or money-center banks. Referring again to Attachment A, Figs. A2 and A3 quantities the profit achievable by banks based on the variables described in Figure A2.

The phrase “future value” or “FV” refers to a formula that returns the future value of an investment based on periodic, constant payments and a constant interest rate. In other words, it is the future value, at maturity, of an income stream or an investment made today based on a compounded rate of interest. To calculate the Future Value of a present day investment the formula FV (rate,nper,pmt,pv,type) [e.g., formula used in a Microsoft Excel™ spreadsheet] will return the Future Value of an investment, in which:
Rate is the interest rate per period.
Nper is the total number of payment periods in an annuity.
Pmt is the payment made each period; it cannot change over the life of the annuity. Typically, pmt contains principal and interest but no other fees or taxes. If pmt is omitted, the pv argument must be included.
Fv is the present value, or the lump-sum amount that a series of future payments is worth right now. If pv is omitted, it is assumed to be 0 (zero), and the pmt argument must be included.
Type is the number 0 (end of period) or 1 (beginning of period) and indicates when payments are due.

A “GIC” or “guaranteed investment contract” (also called “Bank Investment Contract”) is a contract between an issuer (mostly a bank or an insurance company) company and a high net worth client, corporation pension fund or 401 (k) plans that guarantees a specific rate of return on the invested capital over the life of the contract. Although the issuer takes all market, credit and interest rate risks on the investment portfolio, it can profit if its return exceeds the guaranteed amount. Only the credit rating of the issuer offers assurance to the contract purchaser that the desired rate of return on the investment will be achieved.

The phrase “interest rate swap” is a contract in which two counter-parties agree to exchange interest payments of differing character based on an underlying “notional principal” amount that is never exchanged. There are three types of interest swaps: “coupon swaps” or exchange of fixed rate for floating rate instruments in the same currency; “basis swaps” or the exchange of floating rate for floating rate instruments in the same currency; and “cross currency interest rate swaps” involving the exchange of fixed rate instruments in one currency for floating rate in another. In its simplest form, the two contracting parties to an interest rate swap exchange their interest payment obligations (no principal changes hands) on two different kinds of debt instruments.

The term “instruments” refers to debt instruments in general that are issued by a financial institution or a corporate issuer and in the invention process, these instruments make up the investment portfolio used to close transactions.

The “internal rate of return” or “IRR” is the average annual yield earned by an investment during the period held. In a financial instrument the IRR is equal to the “Yield to Maturity” as defined below.

The term “investment Cycle” or “cycle” refers to a series of steps leading to a successful escrow closing that specifically includes the purchase of instruments and a refinancing that result in a net arbitrage profit at the end of each cycle. Cycles can be repeated at will in whatever frequency is desired by all the participants in a transaction.

The “issuer” or “original issuer” is a corporation, government or other legal entity having the authority to offer its bonds, notes, or stock certificate for sale to investors. It also applies to a bank that issues a standby letter of credit or bank guarantee for a particular customer, valid for a stated period.

The “lending rate” is the annual interest rate charged by a financial institution on a loan.

The term “leverage” in finance means the money that is borrowed to increase the return on invested capital. In banking it is the use of funds purchased by a bank in the money market or borrowed from depositors to finance interest-bearing assets, principally loans. Banks invest their depositors' money in loans at rates high enough to cover the lender's cost of funds and operating expenses, and yield a profit margin or spread. In finance it is the use of debt or senior securities to get a higher return on owner's equity capital. In banking, leverage is also the amount that a bank can lend out with the refinancing support of its Central Banker, money center banks, home mortgage refinancing institutions or the global inter-bank refinancing markets (e.g. London Inter-Bank Overnight Rate—“LIBOR”) based on the bank's balance sheet capital reserves. [In the United States for instance, a bank can lend out $10 for every $1 of capital reserve it maintains on its books. Banks profit from a leveraging process by: (a) lending available cash at retail interest rates followed by a refinancing (or discounting) of the collateral at a lower discount rate; (b) repeating this lending and refinancing cycle until such time as the full 10:1 leverage has been achieved as permitted by the Central Bank. As an example, a bank that receives a $1 million proceeds for the sale of a ten-year financial instrument can achieve a gross profit of $1.09 million over the same ten year period, assuming a leverage of 9 times proceeds, a cost to the Issuer of 6.25% interest per annum, a reinvestment of 50% of the proceeds in US Treasuries and 50% in retail mortgage, a revenue yield to maturity of 4.15% on US Treasuries, a revenue yield of 5.87% on mortgage loans, and a bank refinancing rate of 2.75%.]

The “loan to value” is the amount loaned (the principal) relative to the face value of the supporting collateral, e.g. a loan of $900 secured by securities having a $1,000 face value represents a 90% loan to value.

A “money center bank” is a bank located in a major financial center that participates in both national and international money markets. Money Center Banks provide small regional banks with banking facilities and services the smaller banks do not have.

The term “novation” applies to an agreement to: (1) replace one party to a contract with a new party. The novation transfers both rights and duties and requires the consent of both the original and the new party and (2) the replacement of an older debt or obligation with a newer one.”

An “option to call” or “call option” is a contract that grants the buyer of an option the right (but not the obligation) to purchase currencies, financial futures, or securities at a stated price, called the “exercise price.” In this invention, a Call Option is a contract between the “grantor” and the “grantee” in which the grantor grants an option to the grantee to call (right to purchase) from the grantor the investment or loan portfolio of the grantor at the exercise price prior to the expiration date of the option. In a Call Option, the right to exercise the option belongs to the grantee, and the grantee is obligated to perform if the grantee chooses to call.

An “option to put” or “put option” is the opposite of a Call Option where the rights and obligations of the parties are reversed. A Put Option obligates the seller of an option to buy a portfolio of loans or securities if the purchaser chooses to exercise his “right to sell” under the option.

The “option strike price” is the exercise price of the Call or the Put Option. In the case of a Call Option, it is the purchase price and in the case of a Put Option, it is the selling price.

The “participants” or “transaction participants” refer to the individuals or legal entities that cooperate with a transaction manager to create a transaction closing. It includes one or more transaction manager/s, investor/s, financial institution/s, lender/s, escrow agent/s, exit buyer/s or repo buyer/s.

A “pledge/security agreement” is an agreement in which a borrower pledges an asset, as collateral, as a security interest to a lender for a loan. The Pledge/Security Agreement grants the lender a security interest in the pledged asset of the borrower until the loan is repaid.

The term “portfolio” (of financial instruments or loans) to describe in the invention is an investment portfolio that consisting of three financial products termed herein as Instruments No 1, No 2 and No 3.

The term “present value” is a formula that is widely used in discounted cash flow analysis. It calculates today's value of a payment or stream of payment amounts due and payable at some future date, discounted by a compound interest rate or discount rate. In other words, it is the total amount that a series of future payments is worth today. To calculate the Present Value of an investment or a series of cash flows the formula PV(rate,nper,pmt,fv,type) [e.g. as used in a Microsoft Excel™ spreadsheet] will return the present value of an investment, in which:
Rate is the interest rate per period.
Nper is the total number of payment periods in an annuity.
Pmt is the payment made each period and cannot change over the life of the annuity. If pmt is omitted, the fv argument must be included.
Fv is the future value, or a cash balance you want to attain after the last payment is made. If fv is omitted, it is assumed to be 0 (the future value of a loan, for example, is 0). If fv is omitted, the pmt argument must be included.
Type is the number 0 (end of period) or 1 (beginning of period) and indicates when payments are due.

A “rating” is a risk rating issued by such rating agencies as Standard & Poor's, Moody's Financial Services, Fitch Ratings, A.M. Best or Thompson Bankwatch or any other such recognized rating institutions that evaluates the risk of default of a particular issuer of a security or instrument, or in the case of a structured finance transaction, the risk of default based on a particular structure. A rating can either be based on a particular issuer or on a particular security or instrument issued by an issuer.

A “refinancing” is the process of creating cash liquidity by selling, discounting or pledging an investment or an illiquid asset obtained as collateral for a loan. Frequently a bank will make a loan secured by certain collateral, then turns around and “refinances” itself, by converting the paper collateral into cash that can be relent by pledging in turn, the initial borrower's collateral, to the Central Bank under the “Borrower in Custody” program or to another bank in the inter-bank loan market. Referring to Attachment A, Fig. A1 describes the process of how banks refinance themselves.

A “repurchase agreement” or “repo agreement” between a seller and a buyer is an agreement whereby the seller agrees to repurchase the securities at an agreed upon price and, usually, at a stated time.

A “reverse annuity” as described in this invention is represented by instrument No 1. It is an insurance instrument, a security instrument or a bank investment product that guarantees to pay out a pre-agreed cash surrender value annually if the investment product is redeemed prior to maturity. The product gradually builds an increasing cash surrender value that ultimately pays out the full face value at maturity, inclusive of accumulated interest earned over the life of the investment. The payment of the redemption price at maturity is contingent upon receipt by the Issuer of all annual, semi-annual or quarterly payments due by the annuitant or purchaser/holder. A Reverse Annuity product may offer numerous tax-deferral advantages to investors in a high tax-bracket who anticipate receiving regular future income they can shelter by making annual payments under the contract. In this case the redemption amount at maturity consists of a bullet payment that returns to the investor all principal amounts paid together with compounded accrued interest.

A “standby letter of credit” (SLCs) or “bank guarantee” (BGs) is a credit instrument or a contingent (future) obligation of the issuing bank to make payment to the designated beneficiary of the bank's customer (the applicant) fails to perform as called forth under the terms of a contract. SLCs, for this reason, are considered off-balance sheet liabilities in computing bank capital-to-asset ratios. SLCs or BGs can include such terms as irrevocable, unconditional, transferable, divisible, confirmed. SLCs or BGs can be used as credit enhancement instruments to secure future obligations of a borrower. In this case, the lender will normally look to the issuing bank as the credit risk rather than the strength of the borrower's balance sheet. SLCs and BGs can also be designed so as to convert a “contingent” obligation of the bank into a direct obligation to pay regardless of the conditions of performance under a contract. When such a “direct-pay” letter of credit or bank guarantee is issued, the SLC or BG performs the same function as a security instrument that guarantees payment at maturity regardless of the conditions that may prevail between two parties to a contract.

The term “synthetic asset” refers not to an asset or portfolio of assets that are acquired but to an asset whose value is linked to other assets, such as securities, in combination. Hence, the asset is said to be synthetically acquired, and therefore, is said to be a synthetic asset in that the value is artificially created. For example, the simultaneous purchase of a Call Option and sale of a Put Option on the same security or investment portfolio creates a synthetic asset having the same value in terms of capital gain potential as the underlying security itself.

The term “transaction manager” for the purpose of this invention refers to a third party individual or entity that acquires an Option to Call the investment portfolio of an investor consisting of specific tailor-made securities and financial products. Simultaneously, the transaction manager acquires an Option to Put the acquired portfolio to a third-party buyer or to Refinance the portfolio based on pre-agreed terms and conditions. Usually the Call Option and the Put Option are executed simultaneously via a Simultaneous Escrow Closing in order to eliminate any and all transactional risks for the Transaction manager. In this case both the portfolio to be acquired and the cash necessary to guarantee the resale of the portfolio are held in escrow and the closing occurs simultaneously if both conditions exist.

A “trust” is an organization, usually combined with or within a commercial bank, which is engaged as a trustee, fiduciary or agent (with no conflict of interest) by a grantor individual or legal entity in the administration of trust funds or assets. A trustee holds title to property under the trust agreement for the benefit of another person or entity called the “Beneficiary/ies”.

A “trust indenture” is an agreement that establishes the trust and appoints a trustee to manage the assets of the trust. Its provisions set forth the powers of the trustee and establishes the interest of the Beneficiaries in the assets held in trust.

The term “yield” as used herein is the return earned by a portfolio (loan or investment) expressed as an annual percentage of the original investment or loan amount. When used in respect of a particular security (e.g. a bond or a note) it normally refers to the yield to maturity (defined below).

The phrase “yield to maturity” or “YTM” applies to the formula that determines the rate of return an investor will receive if a long-term, interest-bearing investment, such as a bond or note, is held to the maturity date. It takes into account the purchase price, the redemption value, the time to maturity, the coupon yield, and the time between interest payments. Recognizing time value of money, it is the discount rate at which the present value of all future payments would equal the present price of the bond or note, also known as the IRR. It is implicitly assumed that coupons are reinvested at the YTM rate.

A “zero coupon security” or “zc note” or “zc bond” is a security that makes no periodic interest payments but instead is sold at a deep discount from its face value. The buyer of such a security receives the rate of return by gradual appreciation of the security, which is referred to as the face value on a specified maturity date. A zero coupon security can also be created by stripping the principal of a bond or note from its coupons and selling the stripped principal as a zero coupon instrument. The process of stripping the principal and the coupons of a security for sale separately to investors having different investment objectives is normally referred to as stripping. Stripping results in two separate and distinct instruments being created from a single interest-bearing note or bond. These two new securities are normally called “Interest-Only” (I/O) that has the features of an annuity product and “Principal Only (P/O) that has the features of a zero coupon instrument.

Turning now to details of the invention generally, the invention includes the design and implementation of a financial transaction which when executed as prescribed herein, and closed simultaneously in escrow, will result in a net profit for all participants with no risk of loss of principal but only an upside potential. As will be described below, the invention involves the issuance and sale of custom-made, specially engineered and underwritten securities or bank instruments as prescribed by this invention.

The participants in a typical multi-party transaction include one licensed transaction manager to coordinate all aspects of the transaction and the closing, plus at least one or more investor/s to acquire the portfolio in an intra-day closing, one or more financial institution/s to issue the securities or financial instruments, one or more bridge lender/s to provide the refinancing, one or more escrow agent/s (e.g. a law firm) to close the transaction, and one or more exit buyers (at retail) to buy-back the original issuer repo to retire the instruments.

The technology consists of a series of steps, which when executed by the participants in sequential order, as prescribed herein, and with the appropriate legal documentation, will guarantee a profit for all participants. The profit is guaranteed for the investor, the transaction manager, the bridge lender and the issuer through a process that arbitrages the time-value money of a future income stream (present value) with a lower cost refinancing, combined with a system of puts and calls at all levels that secures an exit strategy and locks-in a profit at each level of participation in the transaction.

Referring to the example below, which requires a simultaneous escrow closing, the following steps and processes results in a guaranteed profit for all transaction participants:
a. A portfolio of custom-made, securities (preferably 10 years, or longer) is acquired by an investor for immediate resale. The portfolio is designed with pre-selected objectives (e.g. a financial leverage is created for Instrument No 1 where the face value of the instrument is a multiple of the first year's payment obligation (the leverage); the leverage face value then becomes the value of the transaction where a refinancing can be done at a lower interest rate that the yield; two additional instruments are engineered with the objective of becoming the collateral for the payment obligations to maturity of Product No 1, as well as 100% of the future interest payments over the life of the refinancing.) The portfolio yields an average IRR which is greater than the anticipated refinancing rate in (c) below.
b. A transaction manager who makes no investment in the transaction itself, but profits simply through the creation of a synthetic arbitrage where an option to call the investor's portfolio is matched with a lower cost refinancing.
c. To create the liquidity that enables the transaction manager to exercise his option to call the portfolio of the investor, a bridge loan is arranged at a lower interest rate than the IRR derived from the investment portfolio.
d. A full defeasement of the loan (principal and interest) is achieved through a security/pledge & assignment of the investment portfolio to the bridge lender.
e. After the escrow closing, the bridge lender exercises his option to put the loan portfolio to the issuer of instrument No 1 at a pre-agreed strike price which is greater than the amount of the loan.
f. The original issuer of instrument No 1 repurchases the loan portfolio from the bridge lender at a premium.
g. For an additional cash consideration paid to the transaction manager (the difference between the face value of the portfolio at maturity and the loan to value+the cash surrender value of instrument No 1), a novation agreement is executed and delivered that transfers all rights, title and interest to the portfolio of underlying collateral to the original issuer of instrument No 1, and retires the liability for the loan on the books of the transaction manager.
h. Because the portfolio contains an instrument that was originally issued by its current owner, the instrument has been effectively repurchased by its issuer, and, as such, the issuer is required to reverse the original accounting entry when the instrument was sold. After payment to the previous owner of the cash surrender value, the issuer retires instrument No 1 from its books. This process results in an immediate (a typically substantial) profit to the original issuer (the difference between the amount collected at issuance and the cash surrender value paid.)
i. The original issuer of instrument No 1 has the option to hold the remainder of the investment portfolio to maturity, resell the portfolio to the retail market at cost, or resell the remaining instruments to the issuer/s thereof at a premium.
   The above-identified steps can be repeated as desired to maximize the annual return on investment for all participants through the compounding of profits achieved in each successive transaction closing.

An important aspect of the method and system of the invention that minimizes or eliminates any and all downside risks for the transaction manager/s and investor/s, is to require that each transaction be subject to a simultaneous escrow closing which is guaranteed by multiple, separate three-party (e.g. escrow agent, transaction manager and investor) escrow agreements for each transaction participant (investors, issuers and lenders). Each transaction closing requires the execution and delivery of typical legal documentation, including legal opinions of counsel, as known to those skilled in the art.

The profit for a transaction manager is guaranteed by an arbitrage advantage between the yield average of the investment portfolio for Instruments No 1, No 2 and No 3 (IRR for these 3 products=5.11%, 6.25% and 6.25% respectively in the sample calculations that follow) and the lower cost of refinancing (annual interest rate of 4.71% in the following sample calculations). Since the transaction manager orchestrates both the engineering and synthetic acquisition of the portfolio combined with an immediate refinancing that delivers a positive cash flow. The transaction manager profits from the transaction as demonstrated below without any cash outlay on his part.

The profit for an investor is achieved by simultaneously entering into: (a) an option agreement with the transaction manager that grants the transaction manager an option to call the portfolio (a reciprocal option to put by the investor is optional) at a pre-agreed strike price which is greater than the aggregate cost of the instruments that make-up the portfolio, and (b) an escrow agreement between the escrow agent, the investor and the transaction manager that effectively guarantees that the moneys for the exercise of the call option is in escrow before the investor is required to make the investment (in effect, when the investment is made, the exit is already guaranteed in escrow). The combination of the option and the simultaneous escrow closing guarantees a “riskless-principal” investment for the investor who owns the portfolio for an extremely short time before it is resold on an intra-day basis.

For having made the investor's funds available for an intra-day closing, the investor can make a substantial profit. In the example that follows, a 103.5% option strike price means that the investor will earn 3.5% of invested funds in a single day.

The profit for an original issuer of the reverse annuity instrument No 1 (to be defined below) is guaranteed through an option agreement between the original issuer and the transaction manager that grants the original issuer the option to call the investment portfolio of the transaction manager within a specified period of time after the transaction closes in escrow. If and when the option is exercised, the profit for the original issuer of instrument No 1 is achieved through the retirement of its own instrument from its books. The accounting entry at the time of the repo reverses that done when the instrument was originally sold, with the resulting benefit that the cash surrender value payable by the issuer is less than the amount collected when the instrument was sold. The difference between the sale proceeds and the cash surrender value paid represents the profit immediately earned by the original issuer of instrument No 1.

The profit for a bridge lender is guaranteed through an option agreement with the original issuer of instrument No 1 (defined below) that grants the lender the option to put the loan portfolio to the original issuer at a pre-agreed strike price that is greater than the loan proceeds. The risk between the time the loan is made and the time the loan portfolio is resold (guaranteed by the put option agreement), is minimized by a pledge of the investment portfolio that results in a defeasement of 100% of the principal and interest due and payable under the loan. The combination of the defeasement and the option reduces the lender's risk to that of the ability of the original issuer to pay the exercise price when the option is exercised.

For the example provided below, the following options apply to each transaction. With the exception of options No 3 through No 6 below, the first two options are simultaneously exercised in escrow or the escrow does not close:

Option N^{o} 1:

| | |
|---|---|
| Grantor of the Option: | Investor. |
| Option Holder: | Transaction manager. |
| Nature of Option: | Call exercisable by holder (the Put side of the |
| | equation is guaranteed through the simultaneous |
| | escrow closing requirement and it is not necessary |
| | to include it in the option agreement). |
| Object of Option: | Acquisition of the investment portfolio of the |
| | investor consisting of instruments N^{o} 1, 2 and 3. |
| Strike Price: | 103.5% of the direct cost of each of the three |
| | instruments. |

Option N^{o} 2:

| | |
|---|---|
| Grantor of the Option: | Bridge Lender. |
| Option Holder: | Original issuer of Instrument N^{o} 1. |
| Nature of Option: | Put (and/or call) exercisable by holder (repo by |
| | original issuer) at any time after escrow closing. |
| Object of Option: | Acquisition of the loan portfolio of lender, |
| | including delivery of the underlying pool of |
| | collateral. |
| Strike Price: | 70 basis points over loan proceed. |

Option/s N^{o} 3 and/or N^{o} 4 - (Optional - Pre-Repo Process):

| | |
|---|---|
| Grantor of the Option: | Issuer of instrument N^{o} 1. |
| Option Holder: | Issuer of instruments N^{o} 2 and/or 3. |
| Nature of Option: | Call (and/or Put, as agreed between the parties) exercisable by |
| | holder at any time after escrow closing (pre-repo by original |
| | issuer/s). |
| Object of Option: | Cross purchase of instruments N^{o} 2 or N^{o} 3 with a view to |
| | issuing a series of credit-linked notes at a future date as |
| | described in option N^{o} 5 and 6 below (e.g. if the holder of the |
| | option is issuer of instrument N^{o} 2, then the option will be to |
| | purchase instrument N^{o} 3 from the grantor, and vice versa, . if |
| | the holder of the option is issuer of instrument N^{o} 3, then the |
| | option will be to purchase instrument N^{o} 2 from the grantor). |
| Strike Price: | Cash flow of the underlying instruments discounted based on 5% |
| | YTM (approximately 30 basis points over cost). |

Option/s N^{o} 5 and/or N^{o} 6 (Optional - Only if a Final Repo is envisioned):

| | |
|---|---|
| Grantor of the Option: | Issuer of instruments N^{o} 2 and/or 3 (other than holder). |
| Option Holder: | Issuer of instruments N^{o} 2 and/or 3 (other than grantor). |
| Nature of Option: | Call exercisable by holder at any time after option 4 &/or 5 |
| | is/are exercised (pre-repo). |
| Object of Option: | Purchase of a credit-linked note (a derivative instrument) that is |
| | secured by a pool of instruments deposited in trust. (e.g. if the |
| | holder of the option is issuer of instrument N^{o} 2, then the option |
| | will be to purchase instrument N^{o} 3 from the grantor, and vice |
| | versa, . if the holder of the option is issuer of instrument N^{o} 3, |
| | then the option will be to purchase instrument N^{o} 2 from the |
| | grantor) |
| Strike Price: | Swap of derivatives instruments having the same maturities, |
| | characteristics, and cash flows. |

Option N^{o} 7:

| | |
|---|---|
| Grantor of the Option: | Bridge Lender. |
| Option Holder: | Transaction Manager. |
| Nature of Option: | Put exercisable by holder at any time after escrow closing. |
| Object of Option: | A forfaiting line of credit is made available to the Option Holder |
| | that allows him to put any investment portfolio consisting of a |
| | combination of instruments N^{o} 1, N^{o} 2 and N^{o} 3 to the grantor at |
| | a pre-agreed interest rate at any time. It is advisable for the |
| | grantor of Option N^{o} 7 to match this option with the exit (resale |
| | of the loan portfolio) afforded him by Option 2. |
| Strike Price: | Whatever is agreed upon in terms of interest rates, points, etc. |

The profit for the financial institutions that originally issued instruments No 2 and No 3 below is achieved through a strategy that ultimately leads to a repo and retirement of such products from the issuer's books. This is accomplished in the following two-step process:
1. A credit-linked note is issued pursuant to a securitization process.
2. The note is secured by the underlying debt instruments of the target counterparty (e.g. issuer A secures his credit-linked note with the debt instruments of issuer B, and vice versa).
3. A cross sale of the derivative instruments (or swap) occurs between counterparties (issuer A sells to issuer B its credit-linked note which is secured by instruments of issuer B, and vice-versa). The exercise price of the options is such that no exchange of cash is required between counter-parties.
4. When the counterparties decide that it is time to retire their debt instruments, they simply retire the credit-linked note and transfer all rights, title and interest back to the original issuer of the underlying debt instruments and the repo process is complete.

If in a particular transaction closing the same issuer issues both instruments No 2 and 3, then, for the next closing, it is preferable, but not essential, for transaction to involve a different issuer so that the swap of credit-linked notes envisioned herein between issuers can still occur. The cross ownership of a portfolio of credit-linked notes (credit derivatives) having identical characteristics, maturities and cash flows eliminates any and all counter-party risk while allowing the asset (derivative instrument issued by the swap counter-party) and liabilities (debt instruments held by the counter-party and used as collateral) to remain on the books of each issuer for as long as desired or until the counterparties decide it is time to repo the underlying asset from each other in order to deflate their balance sheets in order to make room for new transactions.

In the event the issuers of instruments No 2 and No 3 above enter into a swap arrangement for the purpose of cross-owning each other's credit-linked notes, and the repo cost (the discount price) is based on a lower yield (e.g. 5% YTM in the following example) than that which must be paid on the underlying debt instruments (e.g. 6.25% YTM in the following example), it is evident that such a swap will result in a negative cash flow (loss) for both issuers. Under those circumstances the repo may not be a feasible option unless the issuers have other reasons to do so where they each benefit from a planned technical loss incurred when the repo is executed. One such advantage occurs when the issuers are financial institutions that have access to both the leverage afforded financial institutions under fractional reserve banking and the yield arbitrage made possible between retail lending rates and wholesale inter-bank discount rates. For these financial institutions, the small yield loss is more than offset by the significant profits achieved elsewhere in the organization with the use of the original sales proceeds derived from the sale of Instruments No 2 and No 3.

### Step 1—Portfolio Creation: Instrument No 1—Reverse Annuity or GIC.

This custom-designed (also referred to herein as “specially-designed”) financial product (hereinafter referred to as “instrument No 1”) is engineered to: (a) increase the borrowing leverage in a fully defeased refinancing and (b) deliver a profit to the original issuer when the instrument is repurchased by the original issuer. It is designed with the intention that it will never mature since it is subject to a repurchase option exercisable by the original issuer prior to maturity. For this reason, the yield achievable is artificial and is negotiable between the transaction manager and the issuer so as to benefit the other participants.

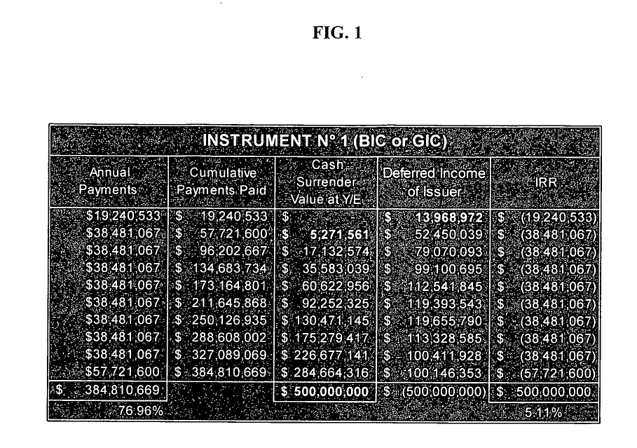

As illustrated in FIG. 1, instrument No 1 incorporates the following design features in the contract:
1. A low initial purchase price (first annual payment obligation which in the case of the example below is 1/26″ of the face value at maturity, also referred to as the leverage).
2. A final payment obligation in the 10^{th} year which is equal to twice the initial purchase price.
3. A flat line payment schedule for each year between the first and last years of the contract.
4. A guaranteed redemption amount (face value) at maturity that pays out in a single bullet payment the paid-in principal plus accrued interest during the life of the instrument.
5. An early redemption penalty which is levied against the holder if the instrument is redeemed at any time and for whatever reason prior to maturity, including if the contract is cancelled due to an event of non-payment of future payment obligations. The loss incurred by the holder is the difference between the cumulative year-to-date payments collected by the issuer less the cash surrender value in the year the redemption or contract termination occurs.
6. A cash surrender value schedule that favors the issuer of the instrument and can result in a substantial profit to the issuer if the contract is terminated, redeemed or retired for whatever reason at any time prior to maturity.

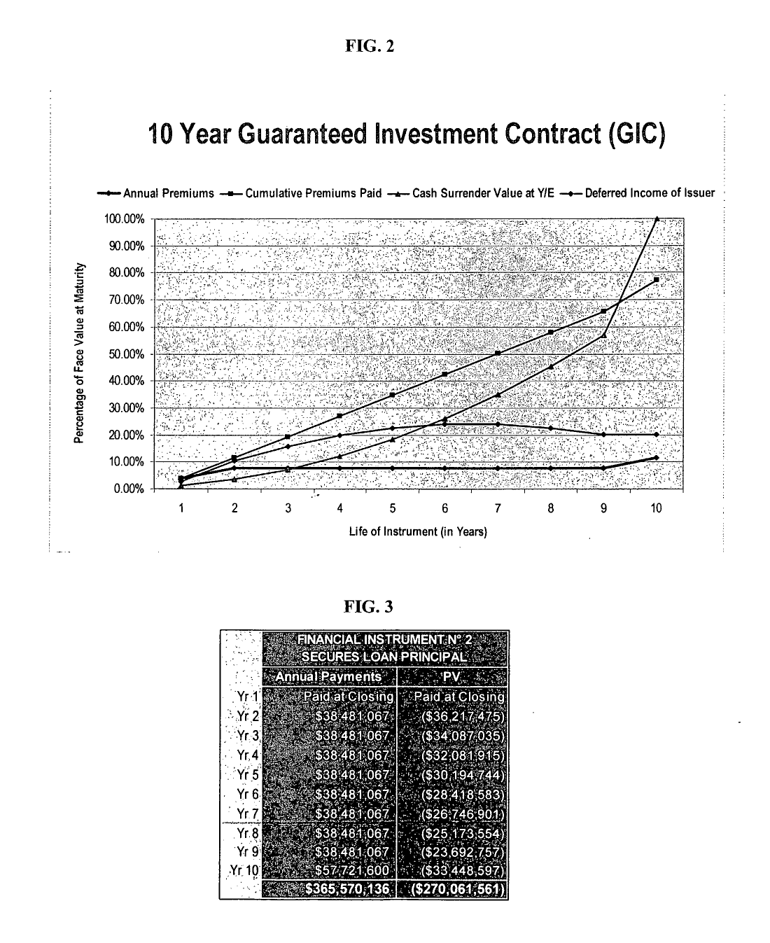

Referring to FIG. 2, an example illustrates the mechanics of an instrument that pays out $500 million at maturity but requires one initial payment of $19,240,053 only (the purchase price), eight annual payment obligations of $38,481,067, and one last annual payment obligations of $57,721,600. The cash surrender value is designed so as to shift the profits to the latter years, which means that if the instrument is retired in the early years, the CSV will be less than the cumulative premiums paid. The CSV at maturity is the face value of the instrument.

### Step 2—Portfolio Creation: Instrument No 2—Annuity Certain.

Instrument No 2 is engineered to guarantee the annual income stream necessary to meet the investor's obligations to the issuer of instrument No 1 during the life of that instrument. The annual income it produces is sufficient to pay the annual payment due under the contract for instrument No 1. When instruments No 1 and No 2 are offered together as collateral on a loan having the same maturity, the repayment of the loan principal at maturity is guaranteed by the redemption value of instrument No 1 at maturity.

Referring to FIG. 3, the chart shows that the combination of the two instruments guarantees the availability of $500 million in ten years to repay the principal of a loan.

Specifications of instrument N^{o} 2 for the purpose of this illustration:

| | | |
|---|---|---|
| 1. | Internal Rate of Return: | 6.25% p.a. |
| 2. | Purchase Price: | $270,061,561 |
| 3. | Annual Income Years 2 to 9: | $38,481,067 |
| 4. | Annual Income Year 10: | $57,721,600 |
| 5. | Total Income to Maturity: | $365,721,600 |
| 6. | Type of instrument: | Option 1: SLCs, BGs, Annuities, |
| | | GICs or BICs |
| | | Option 2: Nine individual zero |
| | | coupon notes, I/O strips or P/O strips |
| | | timed to coincide with the due |
| | | dates of the interest payments. |
| 7. | Type of Issuer: | Insurance companies, banks, |
| | | brokerage firms or corporate issuers. |

### Step 3—Portfolio Creation: Instrument No 3—Annuity Certain.

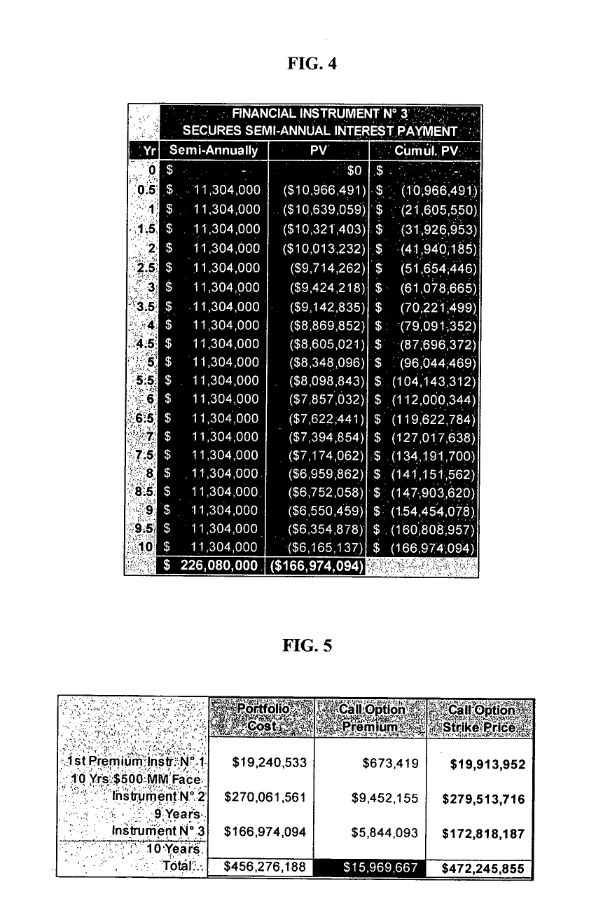

Referring to FIG. 4, instrument No 3 is engineered to guarantee the semi-annual income stream necessary to cover all interest payments that will become due on the refinancing of the portfolio during the entire life of the loan (as described below). The semi-annual income it produces coincides with the loan interest due date and is sufficient to meet the semi-annual interest obligation on the loan. In the illustration that follows, the semi-annual income stream is sufficient to cover semi-annual interest payment of $11,304,000.

Specifications of instrument N^{o} 3 for the purpose of this illustration:

| | | |
|---|---|---|
| 1. | Internal Rate of Return: | 6.25% p.a. |
| 2. | Purchase Price: | $166,974,094 |
| 3. | Semi Annual Income: | $11,304,000 |
| 4. | Total Income to Maturity: | $226,080,000 |
| 5. | Type of instrument: | Option 1: SLCs, BGs, Annuities, GICs |
| | | or BICs. |
| | | Option 2: Nine individual zero coupon |
| | | notes, I/O strips or P/O strips timed to |
| | | coincide with the due dates of the |
| | | interest payments. |
| 6. | Type of Issuer: | Insurance companies, banks, brokerage |
| | | firms or corporate issuers. |

### Step 4—Escrow: Refinancing of Portfolio Via a Secured Loan.

(Refer to Attachment A, Figs. B1 through B5 for a step-by-step, graphic review of the step of the process.)

Prior to the escrow closing, the transaction manager shall have pre-arranged a refinancing to close simultaneously in escrow based on the following terms and conditions:

1. Face value of Instrument No 1 at maturity: $500 million.

2. Loan to Value: 96% of the face value of instrument No 1 at maturity.

3. Net Loan Proceeds: $480,000,000

4. Interest rate: 4.71% per annum

5. Interest Payment: $11,304,000 payable semi-annual in advance.

The debt service of the refinancing is fully securitized so that the collection risk can be shifted to the lender who agrees to look strictly to the issuer of the collateral for repayment (this step is technically referred to in legal terms as “Novation”). The income stream created by the three instruments is sufficient to meet all debt service obligations on the loan.

The process leading to a full novation includes the following steps (also refer to Attachment A, Figs. B1-B6):

First, a standard defeasement of the loan is accomplished through a security/pledge & assignment of the collateral and the income stream to be earned from it to the lender. These agreements include provisions that obligate the lender to apply the investment income earned from the portfolio to satisfy, in full, the indebtedness of the transaction manager for both principal and interest due on the loan. This includes the following income stream:
1. The income derived from instrument No 1 to guarantee the repayment of the loan principal when due at maturity.
2. The income derived from instrument No 2 to guarantee an income stream sufficient to cover all future payment obligations due under instrument No 1 to keep it in full force and effect during its life.
3. The income derived from instrument No 3 to guarantee the payment of the loan interest when due.

Second, after the original issuer of instrument No 1 has exercised his option to repurchase the loan portfolio from the lender, and upon receipt of a payment by the transaction manager of an amount representing, at best, the difference between the face value of instrument No 1 ($500 million) and the Net Loan Proceed ($480 million), the novation agreement is executed and delivered to the lender so as to transfer all rights, title and interest in the collateral to the new owner thereof. The amount, terms and conditions of this settlement is negotiable between the parties. In this example, it is at best $20 million and at a minimum whatever amount is agreed upon between the parties.

Step 5—Escrow: Purchase of Investment Portfolio from Original Investor.

Prior to the escrow closing, the investor shall have entered into an option agreement with the transaction manager giving the transaction manager the right to repurchase the portfolio from the investor at a simultaneous escrow closing upon the exercise of the call option (See Attachment A, Fig. B1). A condition precedent to the acquisition of the portfolio by the investor is that the funds for the execution of the call will need to be deposited in escrow before the portfolio is purchased from the respective issuers.

A qualified investor agrees to purchase instruments No 1, No 2 and No 3 via a simultaneous escrow closing. The investor deposits in escrow the amount necessary to pay for the instruments upon delivery:

| | |
|---|---|
| For instrument N^{o} 1 - Reverse Annuity or GIC | $19,240,533 |
| (See Attachment A, FIG. B2): | |
| For instrument N^{o} 2 - SLC, BG, GIC, BIC or Annuity, | $270,061,561 |
| etc. (see Attachment A, FIG. B3): | |
| For instrument N^{o} 3 - SLC, BG, GIC, BIC or Annuity, | $166,974,094 |
| etc. (See Attachment A, FIG. B4): | |
| Total Amount deposited in escrow to purchase the | $456,276,188 |
| portfolio: | |

To pay the exercise price of the call option, the transaction manager arranges a fully defeased bridge loan from a third-party lender. The acquisition of the portfolio by the investor, the exercise of the call option by the transaction manager, and the refinancing of the portfolio by means of a pre-arranged secured bridge loan will close simultaneously in escrow (See Attachment A, Fig. B5). This process eliminates all risks for both the investor and the transaction manager that they might have to hold on to the investments to term.

Referring to FIG. 5, there is shown a chart that illustrates how the call option strike price is calculated for the example described herein.

When instruments No 1, No 2 and No 3 and offered together as a collateral portfolio to secure a loan having the same maturity dates as to the repayment of the principal and the semi-annual interest, the loan will be deemed to have been fully secured, principal and interest and a full defeasement to be effective (See Attachment A, Fig. B5).

### Step 6—Escrow Closing:

Even though an escrow agreement is executed between the various parties and the escrow agent, the escrow agent is principally retained for the transaction by the transaction manager.

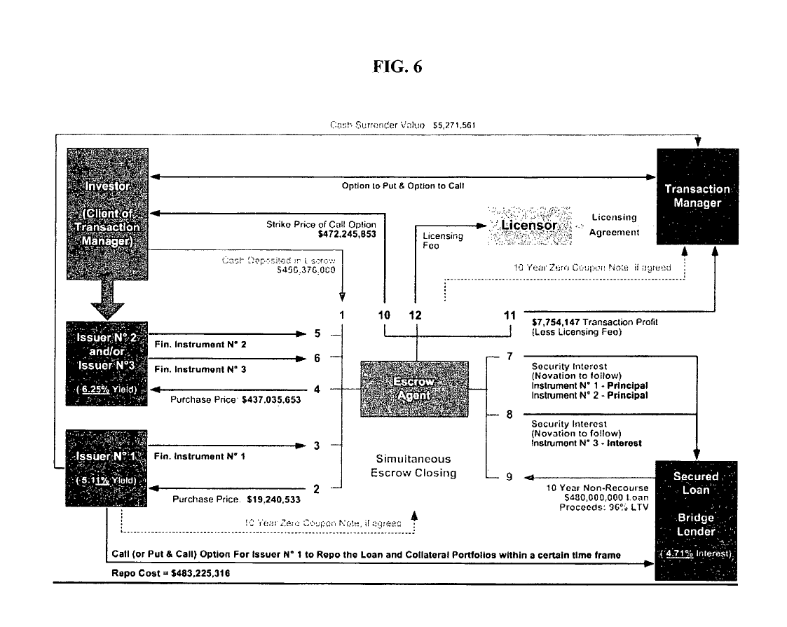

Referring to FIG. 6 for a general overview and see Attachment A, Figs. C1-C5 (for the step-by step closing process), certain escrow closing steps occur as defined below, resulting in a profit for the transaction manager.

Closing Step No 1 (See Attachment A, Fig. C1): The investor deposits $456,276,188 in escrow to cover the cost of instruments No 1, 2 and 3.

Closing Step No 2 through 6 (See Attachment A, Fig. C2): The escrow agent tenders a total of $437,035,653 to issuer of instruments, No 2 and 3 and $19,240,533 to issuer of instrument No 1 whereupon the investor now owns the 3 instruments free, clear and unencumbered.

Closing Steps 7 and 8 (See Attachment A, Fig. C3): The lender receives instruments No 1 to guarantee the repayment of the loan principal at maturity, instrument No 2 to secure the next nine payment obligations due under instrument No 1 and instrument No 3 to secure the semi-annual interest payments.

Closing step 9 (See Attachment A, Fig. C3): Concurrently with the delivery of the 3 instruments above, the transaction manager receives the loan proceeds of $480,000,000 from the lender.

Closing step 10 (See Attachment A, Fig. C4): The investor receives from the transaction manager an aggregate strike price of $472,245,853 upon the exercise of the call option for the purchase of his portfolio. Note that the investor earns a profit of $15,969,667 under this scenario, and that this occurs in a single intra-day closing.

Closing Steps 11 and 12 (See Attachment A, Fig. C5): The balance of $7,754,145 is transferred to the transaction manager (escrow closing step 11 below), and a licensing fee paid simultaneously, is any.

Final Closing Step: The escrow agent receives its fee ($25,000 in this case) from the transaction manager's share of profits, or as otherwise agreed by the parties to the transaction prior to a closing.

Actions Occurring after the Closing the Following Steps Occur Outside of Escrow:
1. Issuer of Instrument No 1 calls the loan portfolio from the bridge lender for a price of $483,225,316 leaving a profit of $3,335,316 for the bridge lender.

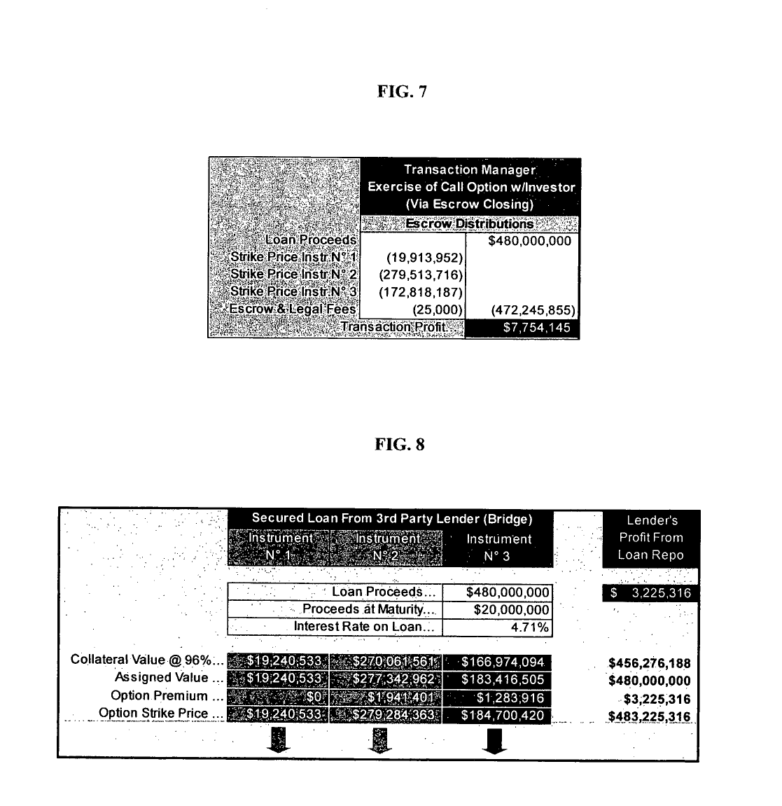

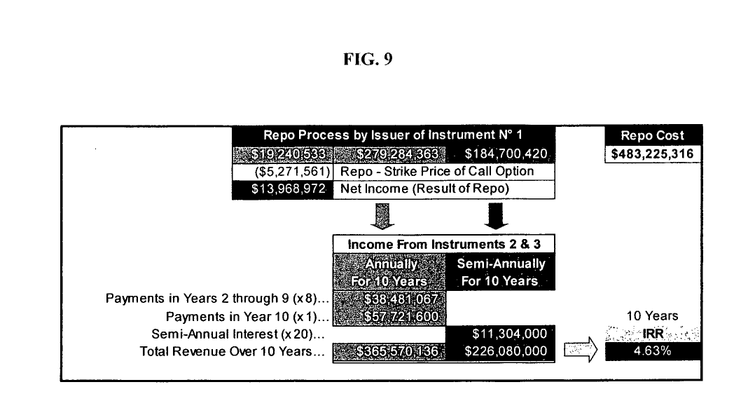

2. At the time of a repo of instrument No 1 (when the novation is duly executed to transfer title of the instrument to its original issuer), the transaction manager receives the cash surrender value ($5,271,561) and relinquishes all rights, title and interests in the instrument. The total profit to the transaction manager is $13,025,708 which is $7,754,145 (transaction profit—see FIG. 7)+$5,271,561.

### Step 7—Optional Resale of Loan Portfolio or Repo by Issuer of Instrument No 1:

Pursuant to an option agreement between the issuer of Instrument No 1 and the bridge lender, this part of the transaction follows the escrow closing at any time in the future when the option holder decides to call the loan portfolio (or, in the case the option also contains a “put” provision, when the lender decides to put the portfolio to the buyer thereof.)

Referring to FIG. 8, this step demonstrates how the bridge lender profits from the transaction by making a bridge loan to facilitate the escrow closing, simultaneously executing an option agreement (preferably with a put provision) to facilitate the resale of the entire loan portfolio.

The following steps occur at this stage of the process (See Attachment A, Fig. B6):
1. The lender makes a ten-year secured loan of $480 million that contains certain early repayment privileges with no prepayment penalty and an assignment provision that allows the lender to transfer the portfolio to any third party of its choice.
2. Shortly after the escrow closing, the lender puts the loan portfolio to the issuer of instrument No 1 (or vice-versa in the case the call provision is exercised).
3. Following the execution of an loan purchase and assignment agreement, the issuer of instrument No 1 pays $483,225,316 to the bridge lender to acquire the loan portfolio, leaving a profit of $3,225,316 for the lender.
4. The lender transfers the portfolio of collateral to the new owner, in this case the issuer of instrument No 1.

Note: The loan is only for 96% of the face value of the collateral. This means that at maturity, when the loan is retired and the collateral is redeemed, the owner/holder of the instrument No 1 will receive a windfall income of $20 Million ($500 million-$480 million). In the event instrument No 1 is sold or transferred prior to maturity, one way to ensure the transfer of this future asset to the seller is through the issuance of a zero coupon note that has the following characteristics:
Face Value: $20,000,000
Term: 10 Years (to coincide with maturity date of Instrument No 1).
Discount Price The present value of $20 million assuming an agreed upon interest rate.

### Step 8—Repo and Retirement of Instrument No 1 by its Issuer:

The acquisition of the loan portfolio in step 7 above is equivalent to a repurchase (repo) by the issuer of Instrument No 1. When the issuer of a debt obligation repurchases its own instrument, accounting rules requires an offset of the original accounting by the amounts that apply to the terms of the repurchase:

Accounting Entries in the Books of Issuer of Instrument N^{o} 1:

| | | Debit | Credit |
|---|---|---|---|
| 1. | Sale of Instrument N^{o} 1: | | |
| | Cash from Sale of Instrument N^{o} 1 (1^{st} Payment) | $19,240,533 | |
| | Reserve for Liability (Cash Surrender Value) | | $5,571,561 |
| | Investment Funds (Asset) | | $13,968,972 |
| 2. | Purchase of Loan Portfolio from Bridge Lender: | | |
| | Loan Receivable | $483,225,316 | |
| | Cash | | $483,225,316 |

Following the transfer of the loan portfolio in step 7 above, the holder and issuer
of instrument N^{o} 1 execute a novation agreement which transfers all rights, title and
interests in the collateral portfolio (including instrument N^{o} 1) to the issuer.
Consideration: $5,571,561 (the cash surrender value of the instrument).

| | | | |
|---|---|---|---|
| 3. | Repo Followed by a Retirement of Instrument N^{o} 1: | | |
| | Reserve for Liability (Cash Surrender Value) | $5,571,561 | |
| | Cash (paid to holder to retire instrument N^{o} 1) | | $5,571,561 |
| | Investment Funds (Asset) | $13,968,972 | |
| | Sales (Income) | | $13,968,972 |

The accounting entries will cause an income of $13,968,972 to flow to the balance sheet of issuer of instrument No 1 upon execution and delivery of the novation agreement by its owner/holder.

After retirement of instrument No 1, the remaining portfolio (instruments No 2 and No 3) will produce an internal rate of return of 4.63%, down from 5.11%. The portfolio can either be held to maturity as an investment or it can be further resold as envisioned in step 9 below.

### Step 9—Exit Strategy for Issuer of Instrument No 1:

The new holder (issuer of original instrument No 1) has the following options:

Option 1: Hold the portfolio consisting of instruments No 2 and No 3 to maturity, in which case the combined IRR will be 4.63% per annum.

Option 2: Resell instruments No 2 and/or No 3 to an institutional buyer at any price that will yield a profit with a view that the buyer will hold such instruments to maturity. In this event, any selling price (discount price) that factors in a yield over 4.63% will result in a profit to the seller.

Option 3: Resell instrument No 2 to its original issuer and/or Instrument No 3 also to its original issuer as part of a repo strategy (See Attachment A, Fig. B6).

Option 4: Swap credit-linked notes as described below (See Attachment A, Fig. D13). This is the option which yields the maximum balance sheet benefits and profit potential for issuers of instruments No 2 and No 3.

Because all parties in a transaction make a profit as demonstrated above, it is in their best interest to execute as many transactions as possible at short intervals between each closing. With this in mind, there are various strategies that can be implemented in order also to create profits for issuers of instruments No 2 and No 3, who are the only parties for who a direct repo does not make sense.

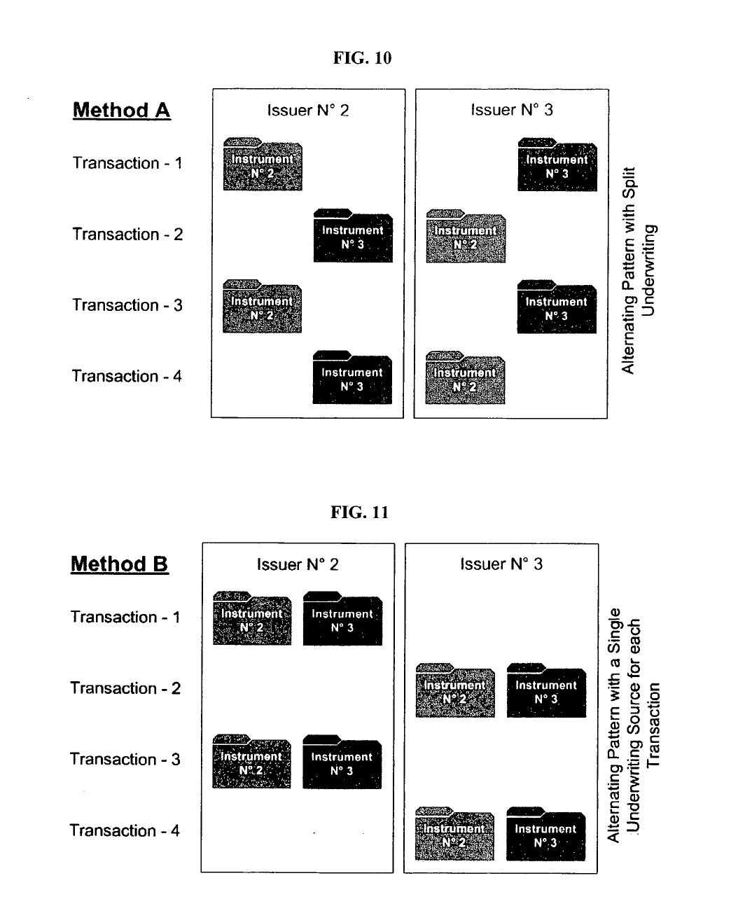

Referring to FIGS. 10-11 as well as Attachment A, Fig. D8, there are shown two methods of alternating the product issuance for each closing sets the stage for a swap of derivatives that can be very advantageous for them also.

In Method A (FIG. 10), issuers 2 and 3 participate in each closing by issuing one instrument each. In the next closing they reverse the type of product issued and sold by each so as to create a mirror image of the obligations and cash flows for each issuer.

In Method B (FIG. 11 as well as Attachment A, Figs. D1-D8), a single issuer sells both instruments No 2 and No 3 for a particular transaction closing. The issuer alternates with each closing and a mirror image of the obligations and cash flows is created for each pair of closings.

If the issuer of Instruments No 2 and No 3 has access, directly or indirectly, to the leverage afforded banks and financial institutions via the fractional reserve banking, significant profits can be achieved through the following process (example based on $100):
1. The bank receives $100 in cash from the sale of a debt instrument (See Attachment A, Figs. D1-D5).
2. It retains $10 as reserves on its books and lends out $90 at retail (See Attachment A, Figs. D2-D6). The least risky investment it can make is to lend to a government having a rating of AAA by buying its year treasury instruments. The higher, but more lucrative risk, is to make loans in the mortgage of commercial market.
3. The institution refinances itself in the inter-bank market (e.g. at LIBOR) through the process known as discounting (See Attachment A, Figs. D3-D7). In the inter-bank market credit is available at wholesale.
4. The process of lending and refinancing itself through discounting is repeated until the 10:1 leverage is achieved. This pre-supposes that all the other balance sheet ratios (e.g. Tier I capital) of the institution will permit such a leverage.
5. At the point where the maximum leverage is achieved, the financial institution's profit is represented by its income from retail interest rates on loans of $900 less its cost of refinancing $900 at wholesale rates. If the spread differential between the retail and wholesale rate is, say, 2%, the institution's profit equals $900×0.01=$18.00 per annum. Even though such a profit does not appear to be much, relative to the initial $100 that made it possible, it represents an 18% return on asset. For this reason, it can be said that a $100 depositor is potentially worth $18.00 to a bank annually which leaves room for negotiating better than normal interest rates for savvy and knowledgeable depositors who understand the worth of their business to a bank or financial institution.

It is advantageous for a financial institution to receive and hold depositor funds on its books for as long as it can. If a debt instrument is issued and it is repurchased shortly thereafter, the benefits of fractional reserve banking is short-lived. Therefore, instead of a repo, it is preferable to use some of the liquidity generated through the leverage and discounting process to repurchase its own instruments.

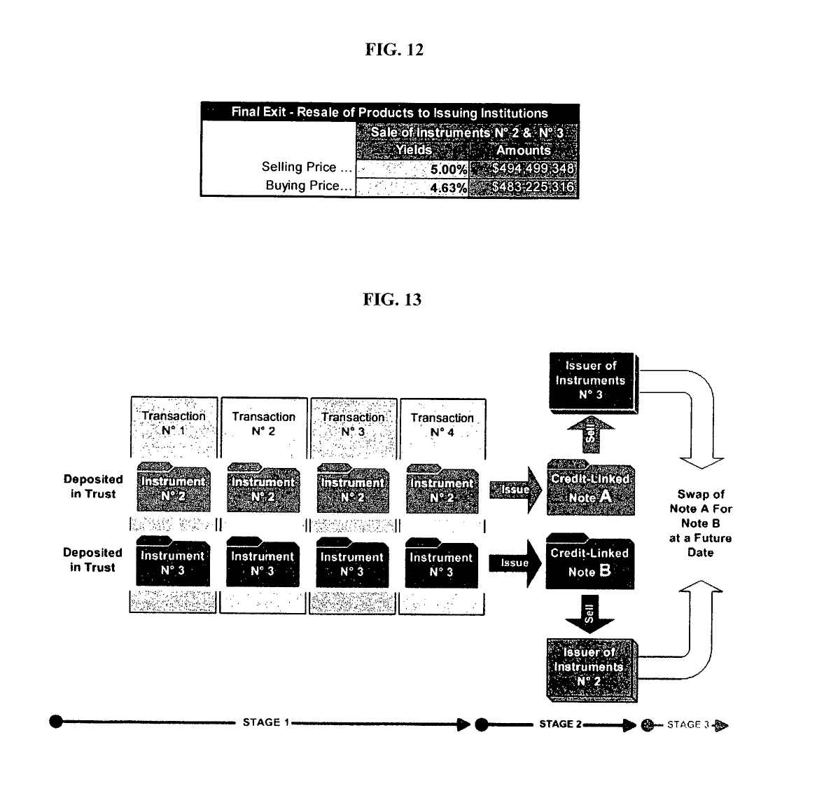

Referring to FIG. 12 as well as Attachment A, Figs. D4-D7, there is a chart which showing the details of a final exit with resale of instruments No 2 and 3 to issuing institutions. In the example, it is assumed that the issuer of instrument No 1 will resell instruments No 2 and 3 with a yield of 5%, thereby making an additional yield differential of 37 basis points which translates into an additional profit of $11,274,032 (difference between the selling price and the buying price below).

Summary of Profits Achieved by issuer of instrument N^{o} 1:

| | Income | Expenses |
|---|---|---|
| Profit from Issuance and Repurchase of | $13,968,972 | |
| Instrument 1. | | |
| Difference between Buying & Selling Price | $11,274,032 | |
| of Portfolio | | |
| Less: Premium paid to Bridge Lender to | | ($3,225,316) |
| Exercise Option | | |
| NET PROFIT | $22,017,688 | |

To enable the issuers of Instruments No 2 and No 3 to retain these debt instruments on their respective balance sheets, the resale of the derivatives thereof must be packaged in stages, as shown in FIG. 13 and described below.
Stage 1: During this stage any number of transaction closings may occur with the result that, after each repo and retirement of instrument No 1, at least one Instrument No 2 and one Instrument No 3 will either be held to maturity by its holder or repackaged and resold as described above through the issuance of a derivative instrument (See Attachment A, Fig D9 and/or D10).
Stage 2: During this stage all instruments No 2 (issued by Issuer No 2) are packaged and deposited in trust to secure the issuance of credit-linked Note A. Simultaneously, all instruments No 3 (issued by Issuer No 3) are packaged and deposited in trust to secure the issuance of credit-linked Note B (See Attachment A, Fig D9 and/or D10).
   Two classes of credit-linked notes are then issued and sold to the opposite issuer so that such sale does not constitute a repo of the original instruments by its issuer (See Attachment A, Fig. D11). All Note A derivatives are sold to Issuer No 3, and vice-versa, all Note B derivatives are sold to Issuer No 2 with the benefit that each issuer can maintain the original instruments on their books for as long as desired so that proceeds from the sale of these instruments can continue to produce profits for each issuer until the time to swap derivatives has come (stage 3). Because Note A is a mirror image of Note B, the underlying indebtedness, risks and cash flows are perfectly matched so as to eliminate completely the counter-party risk inherent in such derivatives (See Attachment A, Fig. D12).
Stage 3: When each issuer (No 2 and No 3) has accumulated a prudent maximum number of derivatives and each decides that it is time to deflate their respective balance sheets to make room for new transactions, they can simply swap derivates, Note A for Note B and vice versa in what is deemed a non-cash exchange of credit-linked notes. Alternatively the swap can be for consideration designed to shift profits or loss from one institution to another. The swap can be between issuer or between their subsidiaries. When the swap occurs, the accounting entries will reverse the asset and liability based on the terms and conditions of the swap but the details of such accounting is outside of the scope of this invention.

Turning now to an alternate way of characterizing the invention, the following numbered paragraphs are provided with the above description.
1. A system, method and strategy of investment (the “Technology”), which can be executed in any currency and amount, and which, when constructed, executed and closed in accordance with Steps 1, 2, 3, 4, 5, and 6 described above (Step 1—Portfolio Creation through Step 6—Escrow Closing), will result in a pre-defined, guaranteed and quantifiable level of profitability for all participants without any risk whatsoever that the principal investment amount of an investor will be lost or depleted, while simultaneously guaranteeing the following results for all other transaction participants: (a) a pre-defined level of profit for the investor, the transaction manager and the lender for the portfolio acquisition, refinancing, discounting and forfaiting; (b) an option to call which when executed by the original issuer of the instrument No 1 will result in a profit for the issuer (e.g. insurance companies, banks, brokerage firms, financial institutions, and/or corporations); (c) an exit strategy that allows each and every participant in the transaction to exit its original position without exposure to ongoing currency fluctuations, changes in interest rates and yields, or default by the issuers of financial products. This Technology comprises the following mechanisms and steps:
   a. The fresh issue underwriting of two or more financial instruments (defined as a group as the “investment portfolio”) designed according the specifications outlined in Steps 1, 2 and 3 above. Note that instruments No 2 and No 3 above can be combined into a single instrument that accomplishes the same objectives, e.g. a note with coupons payable semi-annually.
   b. The purchase of the investment portfolio as part of a simultaneous escrow closing described in Steps 4, 5 and 6 above, where all instruments, payments, loan proceeds, certificates, powers of assignment, powers of attorney, underwriting agreements, tax opinions and legal opinions are exchanged simultaneously by the escrow agent. All steps of the transaction close simultaneously. Neither the delivery of the instruments, delivery of any purchase prices, nor any event required by the terms of any agreement between the parties is deemed to have occurred until such delivery, payment and all such events have occurred. When such delivery, payment and all such events have occurred, they are deemed to have occurred simultaneously. In the event the closing does not occur within the prescribed time frame for whatever reason, all funds, products, instruments, and other assets held in escrow are returned by the escrow agent to the original depositor and the closing is aborted, thus eliminating any and all transaction risks for all the parties.
   c. The exercise of a call option, in escrow.
   d. A simultaneous investment portfolio refinancing mechanism directed or facilitated by the transaction manager in escrow that consists of either one of the following exit strategy options or any combinations thereof:
      i. A fully defeased refinancing of the investment portfolio.
      ii. The forfeiting of the instruments at a price based on the income stream of the instruments that make up the investment portfolio to their present value at a yield to maturity desired by a third-party buyer.
      iii. The sale of the investment portfolio, directly or indirectly, to one of the original issuers of Instruments No 1, 2 or 3 above as prescribed in Step 7 above.
   e. The execution via simultaneous escrow closing of steps (a) through (d) above, guarantee an immediate profit for both the investor/holder and the transaction manager at closing. The profit represents the differential between the refinancing proceeds obtained from the application of one of the three options in paragraph (d) above and the cost of capital used to acquire the investment portfolio. Since the investment portfolio is acquired and resold the same day via a simultaneous escrow closing (an intra-day closing), the transaction is deemed to be a riskless-principal transaction where the refinancing proceeds are exchanged against delivery of all rights, title and interest to the investment portfolio to the lender. In anticipation that all rights, title and interest to the investment portfolio will be transferred to the lender, a novation agreement would normally be executed between buyer and seller to enable the manager to remove the liability from its books and to immediately book the profit as earned income.
   f. Steps (a) through (e) above can be executed repeatedly for the purpose of maximizing investment returns via the compounding of profits achieved through each successive investment cycle or any other form of profit reinvestment. An Investment Cycle is defined as a series of steps (1) (a) through (e) above (hereinafter defined as a “Cycle”) that specifically include the purchase of certain financial products followed by a Refinancing occurring immediately thereafter that results in a net arbitrage profit at the end of each Cycle.
   g. The optional repurchase or repo, by the original issuer of Instrument No 1, of one or more loan portfolios (secured by one or more investment portfolios) from any of the parties involved in the refinancing or repurchase contemplated in paragraphs (d) (i), (ii) or (iii) above with the intent of: (a) retiring Instrument No 1 for the purpose of capturing a significant immediate profit (the difference between the cumulative year-to-date installments paid on Instrument No 1 and the agreed-upon cash surrender value at the time of the Repo); (b) reselling the remaining portfolio in whole or in part to the original issuers, or to one or more third-party institutional buyers or managed funds or hedge funds; (c) freeing-up the issuer's in-house capacity so as to be able to reissue additional products without unreasonably inflating its balance sheet.
2. A system and methodology for a bank, financial institution or corporate entity to issue and sell its own Instrument No 2 and Instrument No 3, and/or a combination of both combined in a single instrument (e.g. a note paying semi-annual coupons) (the “Financial Instruments”), or any other type of financial products described in sections 8, 9, 11, 12 below to a third-party buyer while retaining, or not, an option to repurchase (“Repo”) such product/s through the exercise of a call option in order to have the option of: (i) retiring said Financial Instrument/s from its books eventually, or (ii) facilitating the creation of a series of newly issued derivative financial instruments that derive their value and credit worthiness from the repurchased Financial Instruments (the “Bank Technology”); whereas the overall intent and objective of the Issuer from the onset is as follows:
   (a) to book the proceeds from the sale of its Financial Instruments to a non-related third-party Investor/Holder (the “Proceeds”) on its balance sheet. For a bank, this may qualify as Tier 2 capital;
   (b) to have the complete use of the Proceeds for leveraging purposes (e.g. 10 to 1 in the United States, 20 to 1 in Canada, 12.5 to 1 in Europe) under the fractional reserve banking rules and regulations of the resident country's Central Banks or other regulatory banking institutions;
   (c) to use the maximum available leveraged amount for commercial lending and/or refinancing activities and purposes;
   (d) to facilitate on or off-balance sheet offset of counter-party risk;
   (e) to cooperate with other financial institutions or banks for the purpose of initiating, facilitating or enabling the consummation of a transaction consistent with the above objectives.
This Bank Technology comprises the following mechanisms and steps which are implemented after Paragraph 1 (g) above:
   2.1. The direct or indirect repurchase of the Financial Instruments by the original Issuer at a discounted price acceptable to the seller, either through: (a) the exercise of a put option by the original Investor/Holder or transferee of the Financial Instruments, or (b) the exercise of an option to call by the Issuer, or (b) the creation of a synthetic transaction where a third-party manager simultaneously acquires the above Financial Instruments from the Investor/Holder, through the exercise of a call option, with the intent of putting same to the original Issuer as part of a put option agreement that shall have been pre-executed with the Issuer before exercising the call option.
   2.2. The stripping of principals and/or coupons from the original product, if necessary and/or the aggregation and separation of Financial Instruments into asset pools constituting similar Financial Instruments.
   2.3. The complete offset of counter risk accomplished through the cross issuance and acquisition of derivative products or credit-linked notes (the “CLN/s”) within a repurchase transaction that has one or more of the following features or components: (a) two financial institutions agree to issue the Financial Instruments which are then purchase by a non-related, third-party Investor/Holder, (b) each of the two financial institutions issues its own CLN with the intent of swapping its CLN for the CLN of the other financial institution, (c) each CLN is securitized by the target counterparty's original Financial Instruments deposited in trust pursuant to a trust indenture (the “Underlying Asset”), (d) the Underlying Asset pool used for each CLN is that originally issued by the target swap counterparty so that each CLN derivates its creditworthiness and value from the asset pool issued by the same institution that is targeted to purchase the CLN (the intent being that the ultimate holder of the CLN is also the issuer of the Underlying Asset), (e) the swap of the CLN between the two original issuers.
   2.4. The engineering and subsequent cross issuance and sale or swap of a CLN to the target swap counterparty so as to enable each CLN issuer to hold a derivative instrument instead of having to repurchase and retire its own debt obligations that would prevent further profiting from the use of fractional reserve banking leverage and interest rate/discounting arbitrage involving the use of the Proceeds from the sale of the Financial Instruments.
3. A system in accordance with paragraph 1 wherein said Instrument No 1 is replaced by an insurance policy, guaranteed insurance contract, revolving standby letters of credit or bank guarantees or any other type of financial instrument which replicates the construct of a reverse annuity.
4. A system in accordance with paragraph 1 wherein the maturity of said Instrument No 1 is shortened or lengthened to coincide with a desired portfolio maturity.
5. A system in accordance with paragraph 1 wherein the initial purchase payment installment for Instrument No 1 is increased or decreased relative to the face value payable at maturity so as to increase or decrease the financial leverage in the transaction (first installment amount divided by the face value payable at maturity).
6. A system in accordance with paragraph 1 wherein said Instrument No 1 is eliminated and replaced by extending the maturity of Instrument No 2 by one year and the first installment due under Instrument No 1 is applied to Instrument No 2.
7. A system in accordance with paragraph 1 wherein the cash surrender value of said Instrument No 1 is either increased or decreased, replaced by some other form of benefit, or where the redemption terms are extended or modified to increase or decrease the profit to the issuer in the event the issuer repurchases its own financial product at any time so as to retire it.
8. A system in accordance with paragraph 1 wherein said Instrument No 2 is replaced by one or more zero coupon notes, revolving or non-revolving standby letters of credit or bank guarantees, promissory notes, certificates of deposits, debentures, pay orders, strips (“Strips” which are I/Os or P/Os purchased at a discount) (e.g. “interest-only” or “principal-only” US Treasury strips) that mature concurrently with the maturity date of any form of refinancing wherein the principal needs to be fully secured, including any form of swapping (swap) of the above instruments or their interest coupons that achieve the same desired objective.
9. A system in accordance with paragraph 1 wherein said Instrument No 3 is replaced by a series of one or more zero coupon notes, revolving or non-revolving standby letters of credit or bank guarantees, promissory notes, certificates of deposits, debentures, pay orders, strips purchased at a discount and that are timed to mature concurrently with the due dates of each and every interest payment payable under a secured loan agreement or other form of refinancing where it is necessary to fully secure all future interest payments, including any form of swapping (swap) of the above instruments or their interest coupons that achieve the same desired objective.
10. A system in accordance with paragraph 1 wherein said refinancing is fully defeased by either pledging a portfolio that consists of Instruments No 1, 2 and 3 above or other financial instruments provided for under paragraphs 8 and 9 above as security thereby causing the refinancing to qualify as a fully or partially defeased transaction (non-recourse to the borrower as is normally the case in forfaiting transactions).
11. A system in accordance with paragraph 1 wherein said Instruments No 2 and No 3 are replaced by a single financial product that delivers the same features as contemplated for each of the two separate products (e.g. a medium-term note or promissory note or bond) that pays out a fixed principal amount at maturity and has monthly, quarterly, semi-annual or annual coupons attached that guarantees a future income stream timed to coincide with each future interest payment due date.
12. A system or method in accordance with paragraph 1 wherein Instruments No 2 and/or No 3 is/are replaced by a sinking fund or any other form of trust deposit of cash or marketable securities that guarantees the future payment or repayment of principal and/or interests on a loan or discounting, forfaiting or factoring arrangement, wherein such trust assets are used to secure future obligations under the terms and conditions of a trust indenture or any other form of trust arrangement between grantor and trustee.
13. A system or method in accordance with paragraph 1 wherein the investor, asset manager or arbitrageur uses a special purpose or “bankruptcy-remote” company (“SPC”) to hold the portfolio and all secured debt obligations for the purpose of limiting the risk and/or maximizing the tax benefits to the investors.
14. A system or method in accordance with paragraph 1 wherein the simultaneous refinancing mechanism options envisioned in paragraph 1 (d) (i), (ii) or (iii) above are replaced by the creation of one or more derivative financial instruments (e.g. a senior secured note that derivates its value from the underlying assets deposited in trust—the “Derivative Instrument”) and the Derivative Instrument is secured by a combination of Instruments No 1, 2 and 3 above or other financial instruments provided for under paragraphs 8 and 9 above and sold into the capital markets with the intent that the sales proceeds will be used to refinance or liquefy the investment portfolio.
15. A system or method in accordance with paragraph 1 wherein the refinancing mechanism options envisioned in paragraph 1 (d) (i), (ii) or (iii) above are replaced by the creation of one or more derivative financial instruments (e.g. a senior secured note that derivates its value from the underlying assets deposited in trust—the “Derivative Instrument”) and the Derivative Instruments are issued and sold simultaneously with the acquisition of investment portfolio.
16. A system or method in accordance with paragraph 1 wherein the anticipated defeased loan is replaced by a straight exit sale of the investment portfolio pursuant to the execution of a “novation” agreement that transfers all rights, title and interest to the buyer and allows the seller to remove both the asset and liabilities related to the investment portfolio and/or any bridge refinancing from its books.
17. A system or method in accordance with paragraph 1 wherein the repurchase mechanism (“Repo”) envisioned under 1 (g) above is accomplished through an exchange of stock or other financial instruments of the issuer as full and final settlement for the Repo.
18. A system or method in accordance with paragraph 1 wherein each step of the process envisioned in the simultaneous escrow closing are replaced by one or more escrow closings done at one or more escrow locations or venues and where the execution risks are eliminated through contractual agreements instead of a single escrow agreement between all the parties and the escrow agent.
19. A system or method in accordance with paragraph 1 wherein the purchase or refinancing of Instruments No 2 and 3 is accomplished through any form of: (a) intermediation by a financial institution for the purpose of transferring funds from an ultimate source to an ultimate user; (b) asset exchange involving swaps, options, swaptions or exchanges of like-value instruments; (c) instead of being bought with cash are secured by a pool of underlying assets, whether marginable or not, deposited with the issuing institution to guarantee the issuance of the financial instruments.
20. A system or method in accordance with paragraph 1 wherein the financial products that make up the investment portfolio are in any denomination or currency, or have any future maturity.
21. A system or method in accordance with paragraph 1 wherein the refinancing of the investment portfolio is in any currency.
22. A system or method in accordance with paragraph 1 wherein the refinancing mechanism involves a Repo (repurchase by the original issuer) or a reverse Repo (repurchase by the original issuer with an added requirement that the same instrument will be later reacquired by the same seller).
23. A system or method in accordance with paragraph 1 wherein the Technology is implemented with or without hedging of currency or any other investment risk whatsoever.
24. A system or method in accordance with paragraph 1 wherein the refinancing of the investment portfolio is done through reinsurance.
25. A system or method in accordance with paragraph 1 wherein the registration of the Financial Instruments may or may not include an original CUSIP or ISIN registration number (the “Registration Number”) to facilitate the settlement through one of the recognized fiduciary third-party settlement organizations whether such securities are issued in global form or not, and/or involve any form of securities swap/transfer implemented by a change of the Registration Number of the original securities. CUSIP (“Committee on Uniform Securities Identification Procedures”) is a nine digit securities numbering system used in the US and Canada. An International Securities Identification Number (ISIN) code consists of an alpha country code (ISO 3166) or XS for securities numbered by CEDEL or Euroclear, a 9-digit alphanumeric code based on the national securities code or the common CEDEL/Euroclear code, and a check digit.
26. A system or method in accordance with paragraph 1 wherein the Issuer or Financial Institution acts for its own account or as an intermediation party.
27. A system or method in accordance with paragraph 1 wherein a refinancing or Repo transaction is recognized on that party's balance sheet or alternatively is engineered as an off-balance-sheet financing or refinancing for the purpose of not adding debt on a balance sheet that could potentially deteriorate the balance sheet ratios, whether or not such off-balance-sheet transaction involves the sale of receivables with recourse, take-or-pay contracts, bank financial instruments (e.g. guarantees, letters of credit, loan commitments) and whether such transaction involves or not a credit, market or liquidity risk. The above-described definition of off-balance-sheet financing or refinancing is based upon the definition provided in Barron's “Dictionary of Finance & Investment Terms—6^{th} Edition” and the definition of those phrases in Generally Accepted Accounting Principles (GAAP).
28. A system or method in accordance with paragraph 1 wherein one of the transaction engineering components which are part of the Technology results in an interest rate or yield to maturity differential, actual or synthetically created, and which is extracted as profit, on or off-balance sheet through a process of arbitrage, debt swap, forfaiting or discounting or the swap of future cash flow streams discounted to their present values.
29. A system or method in accordance with paragraph 2 wherein the Repo involves the use of put and call options or not, and with or without intent of creating a synthetic asset.
30. A system or method in accordance with paragraph 2 wherein the Repo involves or not the use of a credit derivative instrument (e.g. a CLN or other form of such instrument).
31. A system or method in accordance with paragraph 2 wherein the number of Issuers involve one, two or more CLN swap counterparties.
32. A system or method in accordance with paragraph 2 wherein the discount price/yield used to calculate the Repo or the swap price of the CLN is lower than that of the yield to maturity achieved under the original issue price of the Financial Instruments, which means that the Repo would result in a technical loss to the original issuer.
33. A system or method in accordance with paragraph 2 wherein the cross swap of the CLNs is achieved or arranged directly between the two swap counterparty financial institutions or through the intermediation services of a third financial institution acting as facilitator or any other third-party arranger or facilitator.
34. A system or method in accordance with paragraph 2 wherein the derivative CLN uses a form of trust-linked note or certificate or not.
35. A system or method in accordance with paragraph 2 wherein the security interest in the Underlying Asset is executed through the issuance of a credit-linked note (CLN) and whether or not the method of securing such CLN employs a trust indenture or any other form of securitization achieved through a trust or custodial form of third-party fiduciary arrangement.

The specific embodiments of the invention as disclosed and illustrated herein are not to be considered in a limiting sense as numerous variations are possible. The subject matter of this disclosure includes all novel and non-obvious combinations and sub-combinations of the various features, elements, methods, functions and/or properties disclosed herein. No single feature, function, element or property of the disclosed embodiments is essential. The following claims define certain combinations and sub-combinations which are regarded as novel and non-obvious. Other combinations and sub-combinations of features, functions, elements, methods and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. A method of performing a multi-participant financial transaction that includes a lender and that will result in a net profit for all participants, comprising:
acquiring and forfaiting an investment portfolio formed from plural financial instruments via a simultaneous escrow closing, thereby making a riskless-principal transaction wherein the refinancing proceeds are exchanged against delivery of all rights, title and interest to the investment portfolio to the lender.

2. A method of performing an investment cycle with multiple participants that will result in a net profit for all participants, comprising:
underwriting an investment portfolio formed from plural financial instruments;
purchasing the investment portfolio as part of a simultaneous escrow closing that requires plural closing documents and exchanging simultaneously all closing documents;
aborting the simultaneous escrow closing in the event the simultaneous escrow closing does not occur within a preselected time, thus eliminating any and all transaction risks for all participants;
exercising a call option, in escrow; and
choosing a simultaneous-investment-portfolio-refinancing mechanism that functions in escrow and includes an exit strategy substep chosen from the group consisting of the following substeps:
performing a defeased refinancing of the investment portfolio;
forfaiting the financial instruments in the investment portfolio at a price based upon the relationship of the income stream of the instruments to their present value at a yield-to-maturity desirable to a third-party buyer;
selling the investment portfolio to one of the issuers of the financial instruments; or
combinations of at least two of the substeps.

3. The method of claim 2, including the step of repeating the investment cycle recited in claim 2.
